(19) United States
(12) Patent Application Publication
(10) Pub. No.: US 2021/0144200 A1
(43) Pub. Date: May 13, 2021

(54) RESOLVING OUTSTANDING AFFINITIES BETWEEN A SERVER CLUSTER MEMBER AND ITS CLIENTS

(71) Applicant: INTERNATIONAL BUSINESS MACHINES CORPORATION, Armonk, NY (US)

(72) Inventors: Michael D. Brooks, Southampton (GB); Philip Ivor Wakelin, Eastleigh (GB); Alan Hollingshead, Eastleigh (GB); Julian Charles Horn, Eastleigh (GB)

(21) Appl. No.: 16/680,555

(22) Filed: Nov. 12, 2019

(51) Int. Cl. H04L 29/08

(52) U.S. Cl. CPC H04L 67/1027; H04L 67/14

(57) ABSTRACT

Embodiments for resolving outstanding affinities between a server cluster member and its clients are presented. Outstanding affinities between the server and the client may be identified in response to the server restarting. A reconnection request may then be generated and communicated to the client. Responsive to a first server of a server cluster restarting following a failure of a connection between a client and the first server, identifying, by an affinity analysis component, the outstanding affinity between the first server and the client. Responsive to identifying the outstanding affinity between the first server and the client, communicating, by a reconnection component, a reconnection request for reestablishing the connection between the first server and the client.

### BACKGROUND

The present invention relates generally to the field of communication between a server cluster member and its clients, and in particular to resolving an outstanding affinity between a server cluster member and its clients.

A cluster of servers can be accessed by its clients using a common network endpoint. Individual clients access the services of a single region in the cluster by first connecting to the common endpoint and then becoming redirected to a specific server in the cluster. Once connected, the client can then route requests to the specific server region for the lifetime of its connection.

Some client requests may involve recoverable updates being made to resources controlled by both the client and its specific server, and those that are then serialized when the request ends. If a connection is lost because of a network error, or the failure of the client and/or its server during this process, further serialization work is only carried out once the connection is re-established.

It may be advantageous to provide a mechanism for clients to be informed of servers restarting, so that the clients know when to attempt to resolve outstanding affinities.

### SUMMARY

The present invention provides a method for resolving an outstanding affinity between a server cluster member and its clients. Such a method may be computer-implemented.

The present invention further provides a computer program product including computer program code for implementing a proposed method when executed by a processing unit. The present invention also provides a processing system adapted to execute this computer program code.

The present invention also provides a system for resolving an outstanding affinity between a server cluster member and its clients.

According to an aspect of the invention, a computer-implemented method is provided for resolving an outstanding affinity between a server cluster member and its clients. The method comprises, responsive to a first server of a server cluster restarting following a failure of a connection between a client and the first server, identifying an outstanding affinity between the first server and the client. The method also comprises, responsive to identifying an outstanding affinity between the first server and the client, communicating a reconnection request for reestablishing a connection between the first server and the client.

According to another aspect of the invention, a computer program product is provided. The computer program product comprises a computer readable storage medium having program instructions embodied therewith, the program instructions executable by a processing unit to cause the processing unit to perform a method according to a proposed embodiment.

According to another aspect of the invention, a computer system is provided comprising at least one processor and the computer program product according to an embodiment. At least one processor is adapted to execute the computer program code of said computer program product.

According to yet another aspect of the invention, a system is provided for resolving an outstanding affinity between a server cluster member and its clients. The system comprises an affinity analysis component configured to, responsive to a first server of a server cluster restarting following a failure of a connection between a client and the first server, identify an outstanding affinity between the first server and the client. The system also comprises a reconnection component configured to, responsive to identifying an outstanding affinity between the first server and the client, communicate a reconnection request for reestablishing a connection between the first server and the client.

### BRIEF DESCRIPTION OF THE DRAWINGS

Preferred embodiments of the present invention will now be described, by way of example only, with reference to the following drawings, in which:

FIG. 1 depicts a pictorial representation of an example distributed system in which embodiments of the present invention may be implemented;

FIG. 2 is a schematic diagram of a distributed communication system according to an embodiment;

FIG. 3 depicts a modification to the embodiment of FIG. 2; and

FIG. 4 illustrates a system according to another embodiment.

### DETAILED DESCRIPTION

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method may be a process for execution by a computer, i.e. may be a computer-implementable method. The various steps of the method may therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention. Further, a component may be an integration flow that is executed by one or more processing units.

A client transaction processing system may include a client computing device connected via a network with a transaction processing server cluster including multiple servers. The client computing device may include a transaction processing program and be configured to communicate via the network with a server transaction processing program which performs a transaction using one or more of the multiple servers which carry out units-of-work. A server cluster may have a single identifier and may include cloned servers to provide a high availability system.

A typical usage scenario when connecting transaction processing (TP) programs to other TP programs is that connections between partners are to be pre-defined with the network endpoint and have a unique TP identifier. This allows the security and connection properties to be tightly controlled, and is a prerequisite to the ability for TP requests to be routed between different TP servers in a cluster across multiple types of network hops. However, this causes a problem when there is not a one-to-one relationship between the network end point and the TP identifier, as is the case when a cluster of TP servers is listening on a shared TCP/IP end point.

Embodiments of the present invention resolve outstanding affinities between a server cluster member and its clients. Recoverable updates may be resolved following a failure of a connection between a server cluster member and its clients. This may be of particular benefit when the client has established a connection to a second server following the failure.

Outstanding affinities between the first server and the client may be identified in a response to the first server restarting. A reconnection request may then be generated and communicated to the client. The reconnection request may then be used to reconnect the client and the first server and resynchronize the outstanding affinity. In this way, the outstanding affinity may be resolved.

Embodiments may be automatically invoked when a server of a server cluster restarts, or as the result of a network outage or reset.

By way of example, embodiments may provide a server-side component that identifies outstanding affinities when a server of a server cluster restarts. Also, a client-side component may be provided which re-establishes a connection between the client and a first server and then re-synchronize an unresolved transaction of an outstanding affinity. The client-side component may undertake such a process in response to receiving a reconnection request from the server.

Thus, a client may be made aware of a server it has affinities with restarting. There may be provided an approach to reconnecting a server with a client when its restarts. Embodiments may therefore provide approaches to handling connection failures and resolving outstanding affinities that may be caused by such failures.

Embodiments may employ a concept of identifying an outstanding affinity between a first server of a server cluster and a client, in response to the first server restarting following a failure of a connection between the client and the first server. A reconnection request can then be communicated from the first server to the client.

Identifying an outstanding affinity between the first server and the client may comprise analyzing a transaction log of the first server to identify one or more outstanding transactions between the client and first server. Embodiments may therefore scan and analyze server log records to discover the identities of clients that were previously connected. Such records may be readily available (e.g. already maintained by conventional servers or server clusters) and identify useful information such as a resource owner, details of recoverable updates, etc. Proposals may therefore leverage logs/records that are already typically available for a server cluster member.

Some embodiments may also include determining the server cluster that the first server belongs to, in response to the first server restarting following a failure of a connection between a client and the first server. For example, embodiments may look for installed cluster services that are listening on a shared network end point. In this way, embodiments may be configured to determine if and when affinity resolution may be required, thereby avoiding unnecessary action being taken.

The reconnection request may comprise an indication that the reconnection request is for re-establishing the failed connection. In this way, a client may be informed about a server restart and thus the possibility of re-establishing a connection for resolving an affinity. A client therefore need only simply wait for a reconnection request, instead of repeatedly reattempting reconnection with the first server.

The reconnection request may also comprise: an identifier of the server cluster to which the first server belongs; and/or an identifier of one or more outstanding transactions between the client and first. In this way, a reconnection request may comprise information useful or necessary for reestablishing a connection and resolving outstanding affinities.

Failure of a connection may comprise at least one of: failure of the client; failure of a network link (i.e. network failure); failure of the first server; communication error; and a failure to reconnect the client, or various other types or categories of connection failure.

Responsive to receiving a reconnection request from the server, a connection is established between the client and the first server and resynchronizing at least one unresolved transaction of the outstanding affinity. In this way, the affinity resolution process is implemented and controlled. For instance, embodiments may provide a component that is deployed at server-side, client-side, or both, so as to resynchronize outstanding transactions.

By way of further example, establishing a connection between the client and the first server may comprise: determining a suitable time to terminate a connection established with the client and to establish the connection between the client and first server. In some embodiments, establishing a connection between the client and the first server may comprise: switching an established connection from a second server in the server cluster to the first server. Embodiments may therefore be configured to cater for new connections that have been established by the client after failure of the connection with the first server. In this way, embodiments may avoid connection conflicts, e.g. where only a single connection with the client is permitted.

An affinity resolution system may be provided that dynamically reconnects a client and cluster server after connection failure, thereby enabling resolution of affinities that may be outstanding as a result of the connection failure. Therefore, identifying outstanding affinities between a client and server of a sever cluster is possible. Reconnecting the client and server is possible so that the outstanding affinities can be resolved. Dynamic and/or automatic resolution of outstanding affinities may therefore be provided.

FIG. 1 depicts an exemplary distributed system in which embodiments of the present invention may be implemented. A distributed system 100 may include a network of computers. The distributed system 100 contains at least one network 102, which is the medium used to provide communication links between various devices and computers connected together within the distributed data processing system 100. The network 102 may include connections, such as wire, wireless communication links, or fiber optic cables.

In the depicted example, first 104 and second 106 servers are connected to the network 102. In addition, clients 110, 112, and 114 are also connected to the network 102. The clients 110, 112, and 114 may be edge devices, for example, personal computers, network computers, IoT devices, or the like. In the depicted example, the first server 104 provides data, such as boot files, operating system images, and applications to the clients 110, 112, and 114. Clients 110, 112, and 114 are clients to the first server 104 in the depicted example. Logs/Records 108 are provided in one or more storage units. As such, logs may be provided as separate instances associated with a server and a client (e.g. an instance associated server 104 and an instance associated with client 114). Alternatively, or additionally, the logs/records 108 may comprise an instance that is centrally accessible via the network 102. The distributed processing system 100 may include additional servers, clients, and other devices not shown.

In the depicted example, the distributed system 100 is the Internet with the network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

Those of ordinary skill in the art will appreciate that the hardware in FIG. 1 may vary depending on the implementation. Also, the processes of the illustrative embodiments may be applied to a multiprocessor data processing system, other than the system mentioned previously, without departing from the scope of the present invention.

Moreover, embodiments may take the form of any of a number of different data processing systems including client computing devices, server computing devices, a tablet computer, laptop computer, telephone or other communication device, a personal digital assistant (PDA), or the like. In some illustrative examples, a system according to an embodiment may be a portable computing device that is configured with flash memory to provide non-volatile memory for storing operating system files and/or user-generated data, for example. Thus, a system according to a proposed embodiment may essentially be any known or later-developed data processing system without architectural limitation.

As detailed above, proposed embodiments provide a method and system for resolving outstanding affinities between a server cluster member and its clients. By way of further explanation, a proposed embodiment of a system 300 will now be described with respect to a distributed communication system including a plurality of clients 310₁, 310₂ and a plurality of server clusters 330₁, 330₂.

Referring to FIG. 2, there is depicted a schematic diagram of a proposed distributed communication system according to an embodiment. The communication system includes a system 300 for resolving outstanding affinities between a client 310₁ and a server 320 of a server cluster 330₁ according to an embodiment.

In this example, first 310₁ and second 310₂ clients communicate via a network 335 with first 330₁ and second 330₂ server clusters for transaction processing. The server clusters each comprise multiple servers for performs transaction processing, and so the servers may carry out units-of-work. A server cluster has a single identifier, such that in this example the first server cluster 330₁ is identified as “CLUSTER #1” and the second server cluster 330₂ is identified as “CLUSTER #2”. Purely by way of further illustration, the first server cluster 330₁ of this example comprise first 320, second 322 and third 324 servers. The first server 320 of the first server cluster 330₁ is identified as “SERVER-A1”, the second server 322 of the first server cluster 330₁ is identified as “SERVER-B1”, and the third server 324 of the first server cluster 330₁ is identified as “SERVER-C1”.

The system 300 includes a cluster identification component 360 that determines a server cluster that a server belongs to, in response to the server restarting following a failure of a connection between a client and the server.

The system 300 for resolving outstanding affinities between a server cluster member and its clients also comprises an affinity analysis component 340. The affinity analysis component 340 is configured to identify an outstanding affinity between a server of a server cluster and a client, responsive to the server restarting following a failure of a connection between the client and the server. By way of example, a failure of a connection may result from a failure of the client, a failure of a server, a communication error, and/or a resetting of a transaction.

In this example, the affinity analysis component 340 is configured to analyze a transaction log that is maintained in a logs/records 355 accessible via the network 355. By analyzing the transaction log, the affinity analysis component may identify outstanding transactions between a client and server.

The system 300 also comprises a reconnection component 350. The reconnection component 350 is configured to communicate a reconnection request from to the client, in response to identifying an outstanding affinity between the server and the client. By way of example, a reconnection request in the example of FIG. 2 comprises an indication that the reconnection request is for re-establishing the failed connection. The reconnection request also includes an identifier of the server cluster to which the server belongs, and an identifier of the outstanding transaction(s) between the client and server.

By way of further explanation and illustration of the proposed concepts, we will now consider how the proposed embodiment of FIG. 2 may resolve an outstanding affinity between the first client 330₁ and the first server 320 of the first server cluster 330₁. More specifically, let us consider an example wherein the first client 310₁ is initially connected to the first server 320 of the first server cluster 330₁ via the network 335 (as indicated by the dashed arrow labelled “C” in FIG. 2) but then the connection fails (e.g. due to the first server 320 crashing).

Responsive to the first server 320 of the first server cluster 330₁ restarting following the connection failure, the cluster identification component 360 determines the server cluster that the first server 320 belongs to (namely the first server cluster 330₁ restarting). Also responsive to the first server 320 of the first server cluster 330₁ restarting following the connection failure, the affinity analysis component analyzes transaction logs available in the database 355 to identify any outstanding transactions between the first server 320 and the first client 310₁.

Responsive to identifying outstanding affinities between the first server 320 and the first client 310₁, the reconnection component 350 communicates a reconnection request to the first client 310₁. The reconnection request comprises an indication that the reconnection request is for re-establishing the failed connection between the first client 310₁ and the first server 320 of the first server cluster 330₁.

In such an example, the first client 310₁ may be provided with a connection component (not illustrated) that is configured to, responsive to receiving a reconnection request from the server, establish a connection between the first client 310₁ and the first server 320 and to resynchronize an unresolved transaction of the outstanding affinity. In doing so, the connection component may be configured to determine a suitable time to terminate a connection that is currently established with the first client 310₁ (i.e. an existing connection) and to establish the connection between the first client 310₁ and first server 320. By way of further example, the connection component may be configured to switch an established connection from a second server 322 in the server cluster 330₁ to the first server 320.

From the above description, it will be appreciated that proposed embodiments may be configured to provide extended functionality in a server region that is driven automatically during restart of a sever (or following network error resolution), to determine if the region is part of a server cluster and was previously connected to one or more clients. This functionality may then reconnect to those clients and attempt to resolve any outstanding affinities.

Further, proposed embodiments may provide a component that is deployed in each client region and configured to detect the arrival of unsolicited connection attempts from servers. Such a component may recognize that these attempts are directed to resolving affinities, and then cooperate with a server to establish short-lived connections that are limited to affinity resolution operations.

For example, FIG. 3 depicts a modification to the embodiment of FIG. 2 wherein the various components of the proposed system 300 for resolving outstanding affinities are distributed across the clients and the server clusters. Specifically, in the modified example of FIG. 3, the reconnection component 350 is provided at part of the server cluster and part of each client. In such a configuration, the reconnection component 350 implemented in a client is configured to understand a reconnection request received from a server cluster member. Also, the affinity analysis component 340 is implemented in the server cluster 330. It will therefore be understood that proposed embodiments may be distributed across clients and server clusters.

Embodiments leverage the understanding that, in a typical distributed transaction processing environment, log records are kept by connected systems that record the progress of updates to the managed resources. These records identify the resource owner, and contain details of recoverable updates that are being made to them, or which were being made when connectivity between a pair of systems is lost. They permit recoverable updates to be resolved by both systems once connectivity is restored.

Making use of such records, proposed embodiments may provide a server side component that can be invoked automatically when a server restarts. Such a component can determine if the server is part of a cluster or not (e.g. by identifying the presence of services listening on a shared network end point).

If found to be part of a server cluster, the proposed component then analyses the log records to determine the identities of all clients it was previously connected to. For each client identified, the component attempts to establish a connection to that client and employs a resynchronisation message sequence to resolve any outstanding affinities. Here, it is noted that re-synchronisation sequences are already known and so such conventional re-synchronisation sequences may be employed by proposed embodiments.

Once re-synchronisation sequence has completed, the connection may be closed and the records relating to the affinities removed from the server's log.

Embodiments of the present invention may also provide a client-side component (e.g. agent code) that is deployed in the client regions to recognize a connection attempt from a server region as one that is made for affinity resolution. When identified as being for such affinity resolution purposes, the client-side component may control the client to accept the connection and participate in a resynchronisation attempt before closing the connections.

By way of further illustration, a new connection is established from a first client to a second server of a server cluster is established following the failure of a first server of the server cluster. The first server restarts and discovers it is part of a server cluster. The first server reads its log and finds it needs to connect to the first client to resolve an outstanding affinity with that client. The first server sends a request to connect to the first client, the connection request being marked for affinity resolution. The first client accepts the connection because it is marked for affinity resolution. The affinity resolution message exchange takes place. The connection between the first server and the first client is then terminated. The connection from the first client to the second server remains established and can be used for further workflow during this process. The server may then look for other clients with which it has affinities.

Embodiments may comprise a computer system 70, which may form part of a networked system 7 illustrated in FIG. 4. For instance, an affinity analysis component configured to identify an outstanding affinity between a server and client according to an embodiment may be implemented in the computer system 70 (e.g. as a processing unit 71). The components of computer system/server 70 may include, but are not limited to, one or more processing arrangements, for example comprising processors or processing units 71, a system memory 74, and a bus 90 that couples various system components including system memory 74 to processing unit 71.

System memory 74 can include computer system readable media in the form of volatile memory, such as random access memory (RAM) 75 and/or cache memory 76. Computer system/server 70 may further include other removable/non-removable, volatile/non-volatile computer system storage media. In such instances, each can be connected to bus 90 by one or more data media interfaces. The memory 74 may include at least one program product having a set (e.g., at least one) of program modules that are configured to carry out the functions of proposed embodiments. For instance, the memory 74 may include a computer program product having program executable by the processing unit 71 to cause the Input/Output (I/O) interface 72 perform a method for resolving outstanding affinities between a server cluster member and its clients according to a proposed embodiment. Program/utility 78, having a set (at least one) of program modules 79, may be stored in memory 74. Program modules 79 generally carry out the functions and/or methodologies of proposed embodiments for partial write operations to memory.

Computer system/server 70 may also communicate with one or more external devices 80 such as a keyboard, a pointing device, a display 85, etc.; one or more devices that enable a user to interact with computer system/server 70; and/or any devices (e.g., network card, modem, etc.) that enable computer system/server 70 to communicate with one or more other computing devices. Such communication can occur via Input/Output (I/O) interfaces 72. Still yet, computer system/server 70 can communicate with one or more networks such as a local area network (LAN), a general wide area network (WAN), and/or a public network (e.g., the Internet) via network adapter 73 (e.g. to communicate determined optimal values of DFWF to edge devices of a distributed network).

Where embodiments of the present invention constitute a method, it should be understood that such a method is a process for execution by a computer, i.e. is a computer-implementable method. The steps of the method therefore reflect various parts of a computer program, e.g. parts of one or more algorithms.

A cluster of server regions can be accessed by its clients using a common network endpoint. Individual clients access the services of a single region in the cluster by first connecting to the common endpoint and then becoming redirected to a specific server in the cluster. Once connected the client can then route requests to the specific server region for the lifetime of its connection.

Some client requests may involve recoverable updates being made to resources controlled by both the client and its specific server, and those recoverable updates require serialization when the request ends. This process, known as syncpointing, involves additional flows over the connection before the updates can be fully hardened. If the connection is lost because of a network error, or the failure of the client and/or its server during this process, then further serialization work will be carried out once the connection is reestablished.

If the client is unable to reconnect to the server immediately then it may choose to preserve the affinity with that specific server, and then connect to another server in the cluster, allowing additional work to be carried out by the client. However, this prevents the outstanding affinities from being resolved until the current connection is dropped and the connection is re-established to the original server.

In current practice, implementations of this architecture, such as the CICS TS® for z/OS high availability function (HA) for IP Interconnectivity (IPIC) lack a mechanism for clients to be informed of servers restarting. Therefore, clients do not know when to attempt to resolve affinities with the servers. Also, in an IPIC HA environment clients connect to one server in the cluster, and servers do not connect directly to clients. (CICS TS is a registered trademark of IBM in the United States).

In an embodiment, a component in determines if the region is part of a server cluster and was previously connected to one or more clients. This function connects to those clients and attempts to resolve any outstanding affinities. This may occur automatically during restart, or may be invoked manually following network error resolution.

A second component, deployed in each client region detects the arrival of unsolicited connection attempts from servers, recognizes these attempts are to resolve possible affinities, and cooperates to establish short lived connections that are limited to affinity resolution operations.

In a distributed transaction processing environment, connected systems keep log records that record the progress of updates to the resources they manage. These records identify the resource owner, and contain details of recoverable updates that are being made to them, or which were being made when connectivity between a pair of systems is lost. They permit recoverable updates to be resolved by both systems once connectivity is restored.

The server-side component is invoked automatically when a server restarts, or as the result of manual actions a network outage. It first determines if the server is part of an HA cluster or not. For instance, if this is a CICS region then it would look for installed TCP/IP services that are listening on a shared network end point.

If found to be part of a server cluster, the server-side component scans the log records in the server to discover the identities of all clients to which the server had previously been connected. For each client found, the server attempts to establish a connection to that client. When successful a re-synchronization message sequence is initiated over the connection to resolve any outstanding affinities.

Once the message sequence has ended, the connection is closed and those records relating to the affinities will have been removed from the server's log. Those log records for any clients that could not be connected to during the server restart operation are preserved for use in the future: either following another restart of the server, or should that client connect to it again.

Agent code is deployed in the client regions to recognize a connection attempt from a server region as one that is specifically there for affinity resolution. This might be achieved via the presence of an indicator in the initial message sent by the server region. When identified for this purpose then the client accepts the connection and then participates in the re-synchronization attempt before closing the connections. Any other type of connection attempt will be rejected by the client, as it is only allowed to have one connection with the server cluster regions at any time.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a storage class memory (SCM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, Python, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for resolving an outstanding affinity between a server cluster member and its clients, the method comprising:
responsive to a server restarting following a failure of a network connection or a failure of the server, the server examining its configuration for an indication of being the server cluster member;
responsive to being the member of the server cluster, scanning log records local to the server to identify each client connected to the server when the server or the connection failure is detected, wherein each log record represents an affinity between the server and a corresponding client;
responsive to identifying the outstanding affinity between the server and each client, communicating an affinity resolution reconnection request for reestablishing a connection between each client and the server;
upon establishing the affinity resolution connection, resynchronizing between the server and each client; and
in response to completing the resynchronizing, the server removing the corresponding log record from the local server, and terminating the corresponding client connection.

2. The method of claim 1, wherein identifying the outstanding affinity between the first server and the client comprises:
analyzing a transaction log of the first server to identify one or more outstanding transactions between the client and first server.

3. The method of claim 1, further comprising:
responsive to the first server restarting following a failure of the connection between the client and the first server, determining the server cluster that the first server belongs to.

4. The method of claim 1, wherein the reconnection request comprises an indication that the reconnection request is for re-establishing the failed connection.

5. The method of claim 4, wherein the reconnection request further comprises at least one of:
an identifier of the server cluster to which the first server belongs; and
an identifier of one or more outstanding transactions between the client and first server.

6. The method of claim 1, wherein the server retains the log record in response to the client refusing the affinity resolution reconnection request.

7. The method of claim 1, further comprising:
responsive to receiving a reconnection request from the server, establishing the connection between the client and the first server and resynchronizing at least one unresolved transaction of the outstanding affinity.

8. The method of claim 7, wherein establishing the connection between the client and the first server comprises:
determining a suitable time to terminate a connection established with the client and to establish the connection between the client and first server.

9. (canceled)

10. A computer program product for resolving an outstanding affinity between a server cluster member and its clients, the computer program product comprising a computer readable storage medium having program instructions embodied therewith, the program instructions executable by a processing unit to cause the processing unit to perform a method comprising:
responsive to a server of a server cluster restarting following a failure of a network connection or a failure of the server, the server scanning its local log records to identify each client connected to the server at the failure, wherein each log record represents the outstanding affinity between the server and the client; and
responsive to identifying the outstanding affinity between the server and the client, communicating a reconnection request for reestablishing the connection between the server and the client, wherein the reconnection request is marked for affinity resolution;
upon establishing the affinity resolution connection, resynchronizing between the server and each client; and
in response to completing the resynchronizing, the server removing the corresponding log record from the local server, and terminating the corresponding client connection.

11. The computer program product of claim 10, further comprising:
responsive to receiving a reconnection request from the server, establishing the connection between the client and the first server and resynchronizing at least one unresolved transaction of the outstanding affinity.

12. A computer system for resolving an outstanding affinity between a server cluster member and its clients, the system comprising:
one or more processors, one or more computer-readable memories, one or more computer-readable tangible storage media, and program instructions stored on at least one of the one or more computer-readable tangible storage media for execution by at least one of the one or more processors via at least one of the one or more computer-readable memories, wherein the computer system is capable of performing a method comprising:
responsive to a server restarting following a failure of a network connection or a failure of the server, the server examining its configuration for an indication of being the server cluster member:
responsive to being the member of the server cluster, scanning log records local to the server to identify each client connected to the server when the server or the connection failure is detected, wherein each log record represents an affinity between the server and a corresponding client;
responsive to identifying the outstanding affinity between the server and each client, communicating an affinity resolution reconnection request for reestablishing a connection between each client and the server;
upon establishing the affinity resolution connection, resynchronizing between the server and each client; and
in response to completing the resynchronizing, the server removing the corresponding log record from the local server, and terminating the corresponding client connection.

13. The computer system of claim 12, wherein the affinity analysis component is configured to analyze a transaction log of the first server to identify one or more outstanding transactions between the client and first server.

14. The computer system of claim 12, further comprising:
a cluster identification component that, responsive to the first server restarting following a failure of the connection between the client and the first server, determine the server cluster that the first server belongs to.

15. The computer system of claim 12, wherein the reconnection request comprises an indication that the reconnection request is for re-establishing the failed connection.

16. The computer system of claim 15, wherein the reconnection request further comprises at least one of:
an identifier of the server cluster to which the first server belongs; and
an identifier of one or more outstanding transactions between the client and first server.

17. The computer system of claim 12, wherein the server retains the log record in response to the client refusing the affinity resolution reconnection request

18. The computer system of claim 12, further comprising:
a connection component that, responsive to receiving a reconnection request from the server: establishes a connection between the client and the first server and resynchronizes at least one unresolved transaction of the outstanding affinity.

19. The computer system of claim 18, wherein the connection component is that determines a suitable time to terminate a connection established with the client and establishes the connection between the client and first server.

20. (canceled)

21. The method of claim 1, wherein the client maintains two simultaneous connections, wherein a first connection is an affinity resolution connection to the server, and wherein the second connection is a transaction processing connection between the client and a second server.

22. The computer program product of claim 10, wherein the client maintains two simultaneous connections, wherein a first connection is an affinity resolution connection to the server, and wherein the second connection is a transaction processing connection between the client and a second server.
